(19) United States
(12) Patent Application Publication
(10) Pub. No.: US 2021/0152257 A1
(43) Pub. Date: May 20, 2021

(54) COMMUNICATION DEVICE, COMMUNICATION METHOD, AND COMMUNICATION SYSTEM

(71) Applicant: SONY SEMICONDUCTOR SOLUTIONS CORPORATION, KANAGAWA (JP)

(72) Inventor: TATSUKI AMIMOTO, TOKYO (JP)

(21) Appl. No.: 16/627,432

(22) PCT Filed: Apr. 17, 2018
(86) PCT No.: PCT/JP2018/015781

§ 371 Date: Dec. 30, 2019

(30) Foreign Application Priority Data
Jul. 7, 2017 (JP) 2017-133630

(51) Int. Cl. H04B 13/00; G06F 3/01

(52) U.S. Cl. CPC H04B 13/005; G06F 3/017

(57) ABSTRACT

To suppress an occurrence of communication unintended by a user. A communication device including: a communication unit that communicates with another communication device via a human body; an acquisition unit that acquires motion information; a comparison unit that compares motion information acquired by the other communication device and received by the communication unit with the motion information acquired by the acquisition unit; and a communication control unit that controls communication between the communication unit and the other communication device, on the basis of a result of the comparison by the comparison unit.

### TECHNICAL FIELD

The present disclosure relates to a communication device, a communication method, and a communication system.

### BACKGROUND ART

In recent years, researches have been conducted on a human body communication system, which is also referred to as a body area network (BAN). The human body communication system may include a terminal worn by each of a plurality of users. Each terminal has at least two electrodes. If a terminal worn by a user generates a potential difference between the two electrodes, electric field distribution is generated on a human body surface of the user. If the user having the electric field distribution and another user come into contact with each other, the electric field distribution is transmitted to the other user, and a potential difference is generated between two electrodes of a terminal worn by the other user. Human body communication (electric field communication) may be achieved by the other terminal extracting a signal from the potential difference.

Patent Document 1 discloses technology as a system using the human body communication. The technology establishes a pairing between a plurality of electronic cameras in a case where communication between the electronic cameras has been established by a plurality of users shaking hands with each other.

### CITATION LIST

### Patent Document

Patent Document 1: Japanese Patent Application Laid-Open No. 2014-60799

### SUMMARY OF THE INVENTION

### Problems to be Solved by the Invention

However, with human body communication adopting a capacitive coupling method, sometimes the human body communication accidentally starts by a spatial coupling, even in a state where the users have not come into contact with each other. Even with human body communication adopting another method, sometimes the human body communication accidentally starts due to unintended contact of users in town, train, or the like.

Therefore, the present disclosure proposes a novel and improved communication device, communication method, and communication system, which can suppress an occurrence of communication unintended by a user.

### Solutions to Problems

According to the present disclosure, there is provided a communication device including a communication unit that communicates with another communication device via a human body, an acquisition unit that acquires motion information, a comparison unit that compares motion information acquired by the other communication device and received by the communication unit with the motion information acquired by the acquisition unit, and a communication control unit that controls communication between the communication unit and the other communication device, on the basis of a result of the comparison by the comparison unit.

Furthermore, according to the present disclosure, there is provided a communication method including communicating, by a communication device, with another communication device via a human body, acquiring motion information indicating a motion of the communication device, comparing motion information acquired by the other communication device with the motion information acquired by the communication device, and controlling, by a processor, communication between the communication device and the other communication device, on the basis of a result of the comparison.

Furthermore, according to the present disclosure, there is provided a communication system including a first communication device having a first acquisition unit that acquires motion information and a first communication unit that transmits information indicating a motion detected by the first acquisition unit; and a second communication device having a second communication unit that communicates with the first communication unit via a human body, a second acquisition unit that acquires motion information, a comparison unit that compares the motion information acquired by the first communication device and received by the second communication unit with the motion information acquired by the second acquisition unit, and a communication control unit that controls communication between the second communication unit and the first communication unit, on the basis of a result of the comparison by the comparison unit.

### Effects of the Invention

As described above, according to the present disclosure, it is possible to suppress an occurrence of communication unintended by a user.

Note that the effect described above is not necessarily limitative. With or in the place of the above effect, there may be achieved any one of the effects described in this specification or other effects that may be grasped from this specification.

### BRIEF DESCRIPTION OF DRAWINGS

FIG. 1 is an explanatory diagram illustrating a configuration of a human body communication system.

FIG. 2 is an explanatory diagram illustrating a configuration of a communication terminal according to an embodiment of the present disclosure.

FIG. 3 is an explanatory diagram illustrating an example of change in positions of communication terminals worn by users shaking hands with each other.

FIG. 4 is a flowchart illustrating operation of the communication terminal according to the embodiment of the present disclosure.

FIG. 5 is an explanatory diagram illustrating an example of change in positions of communication terminals worn by users using the same means of transportation.

FIG. 6 is a flowchart illustrating operation of the communication terminal according to a first modification.

### MODE FOR CARRYING OUT THE INVENTION

Hereinafter, a preferred embodiment of the present disclosure will be described in detail with reference to the appended drawings. Note that, in this specification and the drawings, components having substantially the same functional configuration are provided with the same reference numerals, so that repeated description of these components is omitted.

Furthermore, in this specification and the drawings, a plurality of components having substantially the same functional configuration is sometimes distinguished from one another by providing different alphabets after the same reference numeral. For example, a plurality of configurations having substantially the same functional configuration or logical meaning is distinguished as appropriate, as communication terminals 20A and 20B. However, in a case where each of the plurality of components having substantially the same functional configuration does not particularly need to be distinguished, the same reference numeral alone will be provided to each of the plurality of components. For example, in a case where the communication terminals 20A and 20B do not particularly need to be distinguished from each other, each client will be simply referred to as a communication terminal 20.

Furthermore, the present disclosure will be described in the following order.
1. Outline of Human Body Communication System
2. Configuration of Communication Terminal
3. Operation of Communication Terminal
4. Modifications
5. Conclusion

### 1. OUTLINE OF HUMAN BODY COMMUNICATION SYSTEM

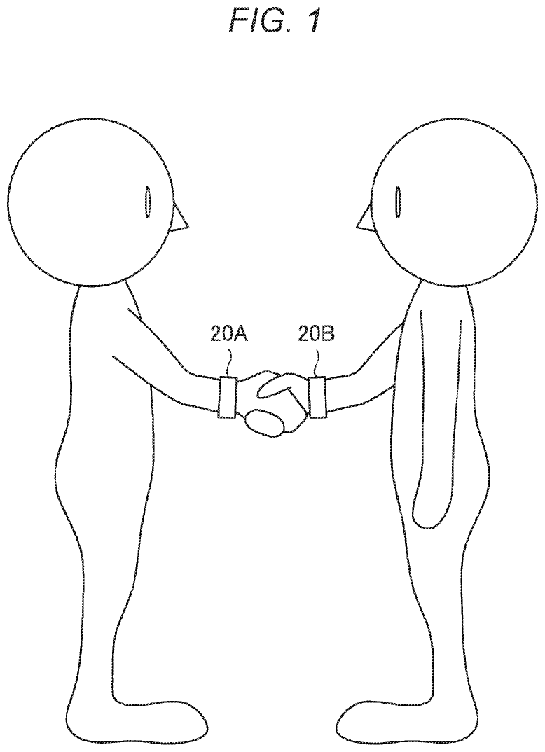

The embodiment of the present disclosure relates to a human body communication system, which is also referred to as a body area network (BAN). BAN communication (human body communication) between terminals in the human body communication system is achieved by electrodes, which are provided to each of the terminals, distributing an electric field on a human body surface. Hereinafter, a specific configuration example of such a human body communication system will be described with reference to FIG. 1.

FIG. 1 is an explanatory diagram illustrating a configuration of the human body communication system. As illustrated in FIG. 1, the human body communication system includes a human body of one or more users and a plurality of communication terminals 20.

The communication terminal 20 is a wearable communication device worn by a user. The communication terminal 20 is connected to another communication terminal via a human body of the user and communicates with the other communication terminal via the human body of the user. For example, in the example illustrated in FIG. 1, a user wearing the communication terminal 20A and a user wearing the communication terminal 20B are shaking hands with each other. Therefore, the communication terminal 20A can perform human body communication with the communication terminal 20B via physical contact between the two users. In the human body communication based on a handshake, it is useful, for example, that business card data including a name, a contact address, and the like of the user is exchanged. Note that a method for the human body communication is not particularly limited. For example, standards of ISO/IEC 17982 (Close Capacitive Coupling Communication (CCCC)) may be applied.

### Background

As described above, it is useful that data is exchanged between the communication terminals 20 by the contact between the users. However, with human body communication adopting a capacitive coupling method, sometimes the human body communication accidentally starts by a spatial coupling, even in a state where the users have not come into contact with each other. Even with human body communication adopting another method, sometimes the human body communication accidentally starts due to unintended contact of users in town, train, or the like. Such data exchange by the human body communication unintended by a user is not preferable.

The present inventor has created the embodiment of the present disclosure in light of the circumstances described above. According to the embodiment of the present disclosure, it is possible to suppress an occurrence of the human body communication that involves the data exchange unintended by a user. Hereinafter, a configuration and operation of the communication terminal 20 by such an embodiment according to the present disclosure will be described one by one in detail.

### 2. CONFIGURATION OF COMMUNICATION TERMINAL

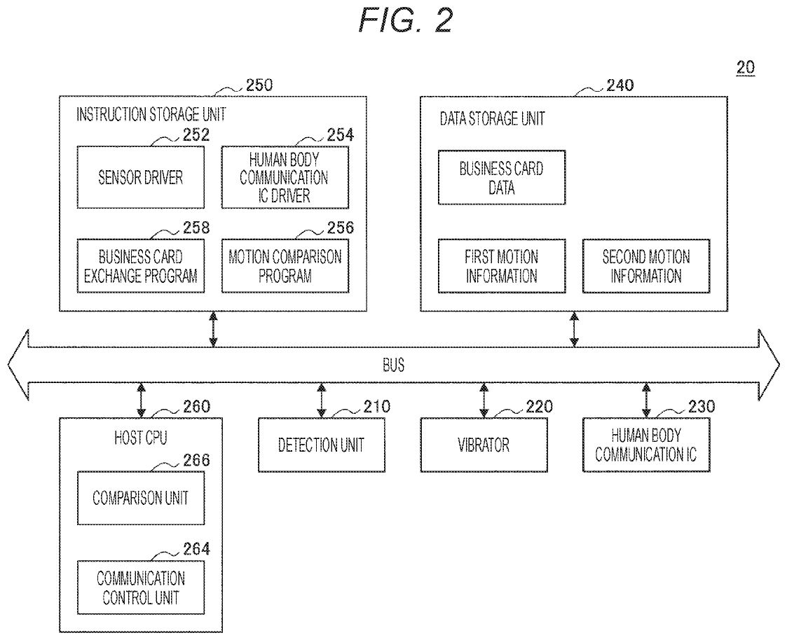

FIG. 2 is an explanatory diagram illustrating the configuration of the communication terminal 20 according to the embodiment of the present disclosure. As illustrated in FIG. 2, the communication terminal 20 according to the embodiment of the present disclosure includes a detection unit 210, a vibrator 220, a human body communication IC 230, a data storage unit 240, an instruction storage unit 250, and a host CPU 260.

(Detection Unit)

The detection unit 210 has a function as an acquisition unit, which acquires motion information of the communication terminal 20. The detection unit 210 may include, for example, a sensor such as an acceleration rate sensor which detects an acceleration rate of the communication terminal 20, a magnetic field sensor which detects the direction of the communication terminal 20, or a global positioning system (GPS) sensor which detects the position of the communication terminal 20. The detection unit 210 may acquire a time-series value indicating an acceleration rate, a direction of the communication terminal 20, or a position of the communication terminal 20, which is detected by the sensor, as the motion information of the communication terminal 20 (first motion information).

Alternatively, the detection unit 210 may process the time-series value detected by the sensor and acquire information after the process, as the first motion information. For example, the detection unit 210 may acquire an absolute value of a value detected by the sensor or a positive/negative sign of the value detected by the sensor, as the first motion information. Furthermore, the detection unit 210 may acquire speed as the motion information by integrating integral of the acceleration rate detected by the acceleration rate sensor. Moreover, the detection unit 210 may calculate a difference between the time-series value detected by the sensor and a value indicating a specific motion, or a feature value of the time-series value acquired by the sensor, and may acquire the difference or the feature value as the first motion information.

For another example, the detection unit 210 may include an image sensor and acquire the first motion information by analyzing time-series image data acquired by the image sensor.

(Vibrator)

The vibrator 220 generates vibration according to control by the host CPU 260. The vibrator 220 may function as a notification unit that notifies a user of a state of the communication terminal 20 by vibration. For example, the vibrator 220 may notify the user, by vibration, of a successful establishment of connection or of a finish of a business card data exchange, when connection between the communication terminal 20 and the other communication terminal 20 is successfully established, or when the business card data exchange, which will be described later, is finished. In a case where the vibrator 220 vibrates when the business card data exchange is finished, the user can complete the business card data exchange more certainly as the user intends, because the user can finish the handshake on the basis of the vibration. Note that, the vibrator 220 is simply an example of the notification unit to notify the user of the state of the communication terminal 20. The communication terminal 20 may be provided with, as the notification unit, a display unit, which notifies the user of the state of the communication terminal 20 by display; or a sound output unit, which notifies the user of the state of the communication terminal 20 by sound.

(Human Body Communication IC)

The human body communication IC 230 is a communication unit including two electrodes and a signal processing unit, to perform the human body communication. The signal processing unit includes a modem unit (PHY, MAC), a transmission processing unit, a reception processing unit, or the like. Transmission of a signal is achieved by the modem unit modulating transmission data provided by the host CPU 260 and generating a modulated signal, and by the transmission processing unit applying the modulated signal to the two electrodes within a predetermined frequency band. Furthermore, reception of a signal is achieved by applying reception processing, such as amplification or down-conversion, to the signal input from the two electrodes, and by the modem unit demodulating reception data from a signal after the reception processing.

In this embodiment, the human body communication IC 230 mainly executes an association sequence for establishment of connection of the human body communication and performs data communication for the business card data exchange.

(Data Storage Unit)

As illustrated in FIG. 2, the data storage unit 240 stores the business card data, the first motion information, second motion information, and the like. The business card data is personal data including a name, an address, affiliation, a phone number, an e-mail address, and the like of a user of the communication terminal 20. The first motion information is information which is acquired by the detection unit 210 and indicates a motion of the communication terminal 20. The second motion information is information indicating a motion of the other communication terminal 20 (opposite terminal), which is a communication partner of the communication terminal 20. The second motion information is acquired by the opposite terminal, transmitted from the opposite terminal, and received by the human body communication IC 230.

(Instruction Storage Unit)

The instruction storage unit 250 stores an instruction for operation of the host CPU 260. As illustrated in FIG. 2, the instruction storage unit 250 stores, for example, a sensor driver 252, a human body communication IC driver 254, a motion comparison program 256, and a business card exchange program 258. The sensor driver 252 is a driver to control a sensor in the detection unit 210, and the human body communication IC driver 254 is a driver to control the human body communication IC 230. The motion comparison program 256 is a program for the host CPU 260 to compare the first motion information with the second motion information, and the business card exchange program 258 is a program to achieve the business card data exchange between the communication terminal 20 and the opposite terminal.

Note that the data storage unit 240 and the instruction storage unit 250 may be a storage medium, such as a non-volatile memory, a magnetic disk, an optical disc, or a magneto-optical (MO) disk. Examples of the non-volatile memory include a flash memory, an SD card, a micro SD card, a USB memory, an electrically erasable programmable read-only memory (EEPROM), and an erasable programmable ROM (EPROM). Furthermore, examples of the magnetic disk include a hard disk and a disc-type magnetic substance disk. Furthermore, examples of the optical disc include a compact disc (CD), a digital versatile disc (DVD), and a Blu-ray Disc (registered trademark) (BD).

(Host CPU)

The host CPU 260 controls overall operation of the communication terminal 20, according to the instruction stored in the instruction storage unit 250. For example, as illustrated in FIG. 2, the host CPU 260 can function as a communication control unit 264 and controls the association sequence for establishment of connection between the human body communication IC 230 and the opposite terminal.

As illustrated in FIG. 2, the host CPU 260 can also function as a comparison unit 266. The comparison unit 266 compares the first motion information with the second motion information, which are stored in the data storage unit 240. Specifically, the comparison unit 266 calculates cross-correlation between the first motion information and the second motion information. The communication control unit 264 controls the business card data exchange between the human body communication IC 230 and the opposite terminal, on the basis of a correlation value, which is calculated by the comparison unit 266, exceeding a threshold value. Hereinafter, a purpose of the host CPU 260 performing such control will be described.

The business card data exchange is desired to be performed between users who intend to exchange the business card data. Therefore, it is conceivable that the business card data exchange is performed on the basis of a handshake between the users, regarding the handshake between the users as an indication of intention of the users.

In this case, it is important how the handshake between the users is determined. With respect to this point, the present inventor has focused on that hands of different users who are shaking hands with each other show a highly correlated motion. If the hands of the different users who are shaking hands with each other show highly correlated motion, each of the communication terminals 20, which are worn on the hands of the different users who are shaking hands with each other, also shows a highly correlated motion.

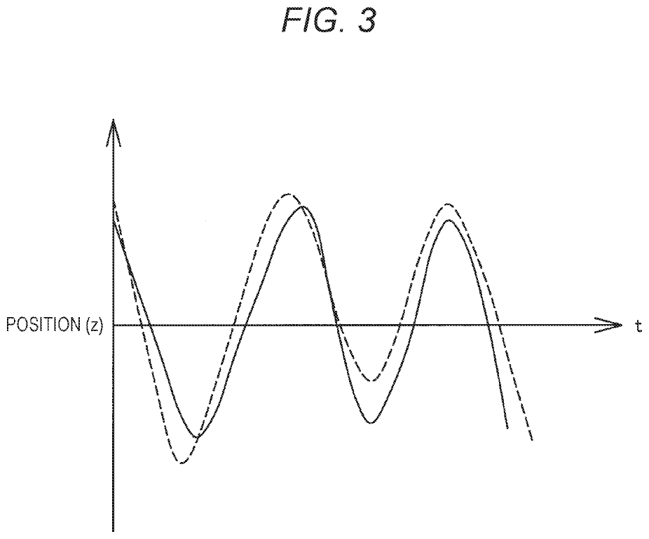

FIG. 3 is an explanatory diagram illustrating an example of change in positions of the communication terminals 20 worn by users shaking hands with each other. In FIG. 3, a solid line indicates change in a position of one communication terminal 20 in a vertical direction (z direction), and a dashed line indicates change in a position of the other communication terminal 20 in the vertical direction (z direction). As illustrated in FIG. 3, it is expected that correlation is shown in the change in the positions of both the communication terminals 20 worn by the users shaking hands with each other.

By focusing on the above, a configuration of the comparison unit 266 that compares the first motion information with the second motion information, which are stored in the data storage unit 240, has been derived. Also, by focusing on the above, a configuration of the communication control unit 264 that controls the business card data exchange between the human body communication IC 230 and the opposite terminal, on the basis of the correlation value, which is calculated by the comparison unit 266, exceeding the threshold value, has been derived. Here, as an additional condition for the business card data exchange, a magnitude of a motion, which indicates the first motion information, exceeding a predetermined value may be used.

With this configuration, it is possible to suppress an occurrence of an business card data exchange based on mere contact between the two users, or the like, which is unintended by the user, because the business card data exchange is performed in a case where the two users are shaking hands with each other.

Note that, only after the handshake between the users, it is secured that the motion of the communication terminal 20 and the motion of the opposite terminal show correlation. Because a state where the users are shaking hands with each other is at least a state where the users are in contact with each other, the comparison unit 266 is only required to compare the first motion information with the second motion information after the users have come into contact with each other. Here, it is possible to determine that the users have come into contact with each other by establishment of the connection between the human body communication IC 230 and the opposite terminal. Therefore, the host CPU 260 may start a sensor in the detection unit 210 on the basis of the establishment of connection between the human body communication IC 230 and the opposite terminal. With this configuration, it is possible to reduce power consumption of a sensor in the detection unit 210 compared to a case where the sensor in the detection unit 210 is always started.

### 3. OPERATION OF COMMUNICATION TERMINAL

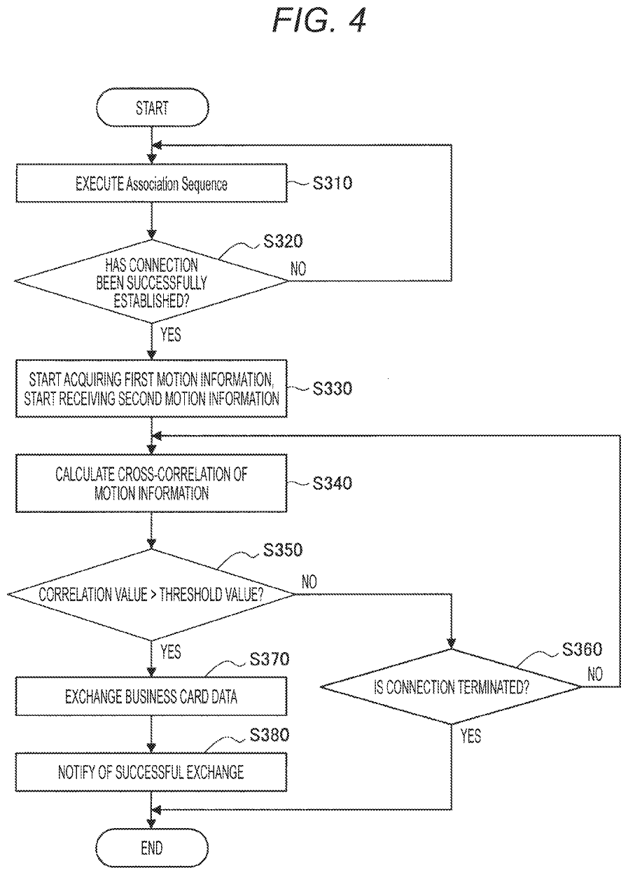

The configuration of the communication terminal 20 according to the embodiment of the present disclosure has been described above. Next, with reference to FIG. 4, the operation of the communication terminal 20 according to the embodiment of the present disclosure will be summarized.

FIG. 4 is a flowchart illustrating the operation of the communication terminal 20 according to the embodiment of the present disclosure. As illustrated in FIG. 4, first, if the communication terminal 20A and the communication terminal 20B have been capacitively coupled with each other via the human bodies of the users, the communication terminal 20A and the communication terminal 20B execute the association sequence for establishment of the connection (S310). Then, if the connection between the communication terminal 20A and the communication terminal 20B has been successfully established (S320/Yes), the communication terminal 20A starts acquiring the first motion information and starts receiving the second motion information from the communication terminal 20B (S330).

Thereafter, the communication terminal 20A calculates the cross-correlation between the first motion information and the second motion information (S340) and determines whether or not the correlation value has exceeded the threshold value (S350). In a case where the correlation value is equal to or less than the threshold value (S350/No), the communication terminal 20A repeats the processing from S340 (S360/No) until the connection between the communication terminal 20A and the communication terminal 20B is finished.

Meanwhile, in a case where the correlation value exceeds the threshold value (S350/Yes), the communication terminal 20A and the communication terminal 20B exchange the business card data (S370). If the business card data exchange has been done successfully, the communication terminal 20A and the communication terminal 20B notify the users of the successful exchange by, for example, vibration of the vibrators 220 (S380).

An example in which the communication terminal 20A calculates cross-correlation of the motion information has been described above. For another example, both the communication terminal 20A and the communication terminal 20B may calculate the cross-correlation of the motion information. Then, in a case where both the correlation value calculated by the communication terminal 20A and the correlation value calculated by the communication terminal 20B have exceeded the threshold value, the communication terminal 20A and the communication terminal 20B may exchange the business card data. With this configuration, it is possible to suppress the occurrence of communication unintended by the user more certainly, because a condition to perform the business card data exchange is more sever.

### 4. MODIFICATIONS

The embodiment of the present disclosure has been described above. Hereinafter, some modifications of the embodiment of the present disclosure will be described. Note that each modification, which will be described hereinafter, may be applied either alone or in combination to the embodiment of the present disclosure. Furthermore, each modification may be applied instead of the configuration described in the embodiment of the present disclosure or may be applied additionally to the configuration described in the embodiment of the present disclosure.

(First Modification)

As described above, in the embodiment of the present disclosure, data communication (business card data exchange) is performed on the basis of the correlation between the two communication terminals 20. Regarding this point, the motions of the communication terminals 20 worn by users using the same means of transportation (for example, train or bus) are correlated.

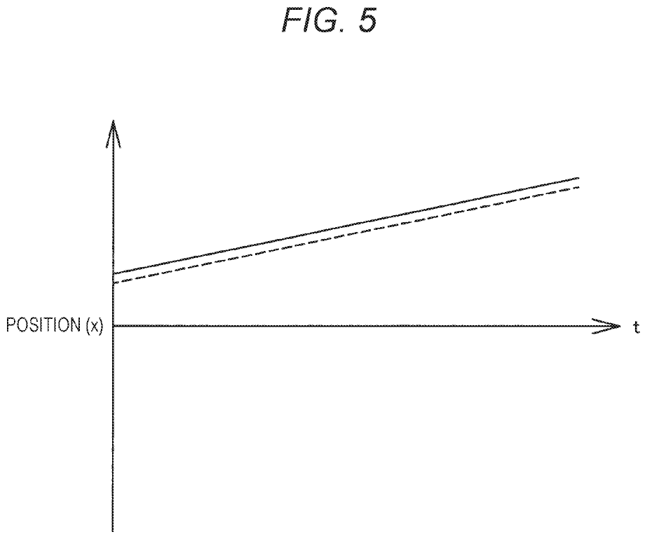

FIG. 5 is an explanatory diagram illustrating an example of change in positions of the communication terminals 20 worn by users using the same means of transportation. In FIG. 5, a solid line indicates change in a position of one communication terminal 20 in a direction of travel (x direction) by a means of transportation, and a dashed line indicates change in a position of the other communication terminal 20 in the same x direction. As illustrated in FIG. 5, the motions of the communication terminals 20 worn by the users using the same means of transportation show correlation.

However, it is not preferable that data communication is performed on the basis of mere contact between the users using the same means of transportation.

Therefore, it may be added to a condition to perform data communication that the motion of the communication terminal 20 has a predetermined pattern. In the case of the handshake, positive and negative directions of the motion switch as illustrated in FIG. 3. However, in the case of the means of transportation, the positive and negative directions of the motion do not switch at least within a short period of time (duration of the handshake), as illustrated in FIG. 5. Therefore, the host CPU 260 may control data communication on the basis of the correlation value of the motion information exceeding the threshold value and of at least one of the first motion information or the motion information of the other terminal has a pattern in which the positive and negative directions of the motion switch within a predetermined period of time.

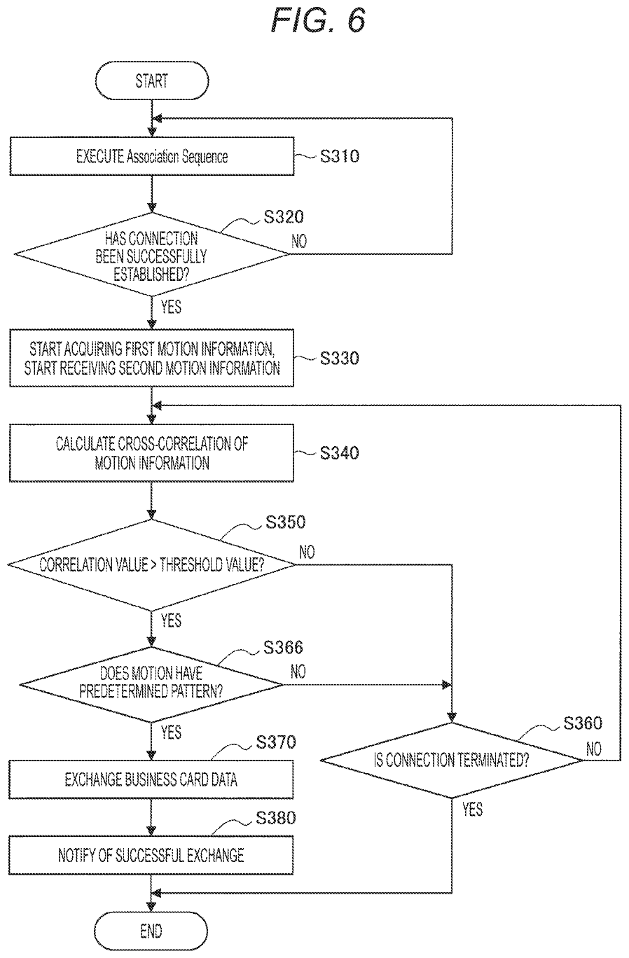

FIG. 6 is a flowchart illustrating the operation of the communication terminal 20 according to the first modification. The processing in S310 to S350 are as described with reference to FIG. 4. In the first modification, after the correlation value is determined in S350 to exceed the threshold value, the host CPU 260 determines whether or not a motion, which is for example a motion indicated by the first motion information, has a predetermined pattern (S366).

In a case where the motion indicated by the first motion information has the predetermined pattern (S366/Yes), the host CPU 260 controls the business card data exchange (S370). Meanwhile, in a case where the motion indicated by the first motion information does not have the predetermined pattern (S366/No), the communication terminal 20 repeats the processing from S340 (S360/No) until the connection to the other communication terminal 20 is finished.

As described above, according to the first modification, data communication is performed on the basis of the motion having a predetermined pattern, such as a handshake, in addition to on the basis of the correlation between the motions of the two communication terminals 20. Therefore, it may be possible to prevent the occurrence of data communication based on the mere contact between the users using the same means of transportation.

(Second Modification)

A handshake often involves shaking of hands up and down. However, handshakes are sometimes performed by merely gripping hands with each other (handclasp). In this case, it is difficult for the two communication terminals 20 to make a correlated motion.

Therefore, after the connection between the two communication terminals 20 is successfully established, each communication terminal 20 may vibrate the vibrator 220 either simultaneously or alternately. In a case where the two users are clasping hands with each other, vibration generated by the vibrator 220 of one communication terminal 20 is considered to be propagated to the other communication terminal 20 via the human body of the user. Therefore, the host CPU 260 may control the business card data exchange on the basis of vibration generated by the vibrator 220 of the other communication terminal 20 being detected by the detection unit 210.

With this configuration, it is possible to achieve the business card data exchange even in a case where a handclasp is performed without shaking hands.

(Third Modification)

An example of the business card data being communicated on the basis of a handshake has been described above. However, the business card data is just an example of a predetermined kind of data, and another kind of data may be communicated on the basis of the handshake. For example, the communication terminal 20 may communicate: an invitation code for the users, who shook hands with each other, to connect with each other using an SNS; a smart key to unlock/lock an electronic lock provided at home; content such as music or movie; a game item; or the like, on the basis of the handshake.

(Fourth Modification)

In the embodiment described above, an example of data communication being performed between the two communication terminals 20 on the basis of the correlation of the motions of the two communication terminals 20 has been described. However, it is also possible to perform data communication between three or more communication terminals 20 on the basis of correlation of the motions of the three or more communication terminals 20. For example, in a case where three or more users stand in a circle and place their hands on top of one another, the three or more communication terminals 20 may be capacitively coupled with one another. Moreover, in a case where the three or more users move their hands up and down while placing the hands on top of one another, the three or more communication terminals 20 are considered to show correlated motions. In such a case, each communication terminal 20 can perform data communication with a plurality of other communication terminals 20.

(Fifth Modification)

The detection units 210 in the two communication terminals 20 performing data communication may have different kinds of sensors. For example, the detection unit 210 in one communication terminal 20 may include the acceleration rate sensor, and the detection unit 210 of the other communication terminal 20 may include the image sensor. Even in a case where different kinds of sensors are used, comparison of motions is possible by both the detection units acquiring motion information of the same dimension. In a case where sampling frequencies of the motion information acquired by both the detection units 210 are different from each other, the host CPU 260 may align the sampling frequencies of both the motion information by down-converting one of the sampling frequencies of the motion information.

### 5. CONCLUSION

As described above, according to the embodiment of the present disclosure, it is possible to suppress the occurrence of the business card data exchange, which is unintended by the user, based on the mere contact or the like between the two users, because the business card data exchange is performed in a case where the two users are shaking hands with each other.

Note that, although the preferred embodiment of the present disclosure has been described in detail with reference to the appended drawings, a technical scope of the present disclosure is not limited to this example. It is obvious that a person with an ordinary skill in a technological field of the present disclosure could conceive of various alterations and corrections within the scope of the technical ideas described in the appended claims, and it should be understood that they will naturally come under the technical scope of the present disclosure.

For example, in the embodiment described above, an example of the business card data exchange performed on the basis of a handshake between two users, who are human beings, has been described. However, the business card data exchange may be performed on the basis of a handshake between a user, who is a human being, and a moving body (for example, a robot resembling a human body), which is not a human being.

Furthermore, each step of the processing by the communication terminal 20 in this specification does not necessarily have to be performed in time series according to the orders described as flowcharts. For example, each step of the processing by the communication terminal 20 may be performed in an order different from the orders described as flowcharts, or may be performed in parallel.

Furthermore, it is possible to create a computer program to cause hardware, such as a CPU, a ROM, or a RAM, which is incorporated in the communication terminal 20, to exercise a function equivalent to a function of each configuration of the communication terminal 20 described above. Furthermore, a storage medium, which stores the computer program, is also provided.

Furthermore, the effects described in this specification are just explanatory or exemplary effects, and are not limitative. That is, with or in the place of the effects described above, the technology according to the present disclosure may achieve any other effects that are obvious, from description of this specification, for a person skilled in the art.

Furthermore, the following configurations also belong to the technical scope of the present disclosure.

(1)

A communication device including:

a communication unit that communicates with another communication device via a human body;

an acquisition unit that acquires motion information;

a comparison unit that compares motion information acquired by the other communication device and received by the communication unit with the motion information acquired by the acquisition unit; and

a communication control unit that controls communication between the communication unit and the other communication device, on the basis of a result of the comparison by the comparison unit.

(2)

The communication device according to (1),

in which the comparison unit calculates a correlation value between the motion information acquired by the other communication device and the motion information acquired by the acquisition unit, and

the communication control unit controls communication between the communication unit and the other communication device, on the basis of whether or not the correlation value calculated by the comparison unit exceeds a threshold value.

(3)

The communication device according to (2),

in which the communication control unit causes the communication unit to communicate a predetermined kind of data with the other communication device, on the basis of the correlation value exceeding the threshold value.

(4)

The communication device according to (3),

in which the communication control unit causes the communication unit to communicate the predetermined kind of data with the other communication device, on the basis of the correlation value exceeding the threshold value and of the motion information acquired by the acquisition unit having a predetermined pattern.

(5)

The communication device according to (4),

in which the predetermined pattern includes a pattern in which positive and negative directions of a motion switch.

(6)

The communication device according to any one of (1) to (5),

in which the comparison unit compares motion information indicating a motion of the other communication device after establishment of connection between the communication unit with the other communication device, and motion information acquired by the acquisition unit after the establishment of the connection.

(7)

The communication device according to any one of (1) to (6),

in which motion information acquired by the acquisition unit includes information regarding time variation of an acceleration rate, speed, or a position of the communication device.

(8)

The communication device according to any one of (1) to (6),

in which the motion information acquired by the acquisition unit includes a difference between a specific motion and a motion of the communication device, or a feature value of the motion of the communication device.

(9)

The communication device according to (4),

further including a notification unit that notifies of successful communication of the predetermined kind of data.

(10)

A communication method including:

communicating, by a communication device, with another communication device via a human body;

acquiring motion information indicating a motion of the communication device;

comparing motion information acquired by the other communication device with the motion information acquired by the communication device; and

controlling, by a processor, communication between the communication device and the other communication device, on the basis of a result of the comparison.

(11)

A communication system including:

a first communication device having a first acquisition unit that acquires motion information and a first communication unit that transmits information indicating a motion detected by the first acquisition unit; and

a second communication device having a second communication unit that communicates with the first communication unit via a human body, a second acquisition unit that acquires motion information, a comparison unit that compares the motion information acquired by the first communication device and received by the second communication unit with the motion information acquired by the second acquisition unit, and a communication control unit that controls communication between the second communication unit and the first communication unit, on the basis of a result of the comparison by the comparison unit.

### REFERENCE SIGNS LIST

20 Communication terminal
210 Detection unit
220 Vibrator
240 Data storage unit
250 Instruction storage unit
252 Sensor driver
254 Human body communication IC driver
256 Motion comparison program
258 Business card exchange program
264 Communication control unit
266 Comparison unit

1. A communication device comprising:
a communication unit that communicates with another communication device via a human body;
an acquisition unit that acquires motion information;
a comparison unit that compares motion information acquired by the other communication device and received by the communication unit with the motion information acquired by the acquisition unit; and
a communication control unit that controls communication between the communication unit and the other communication device, on a basis of a result of the comparison by the comparison unit.

2. The communication device according to claim 1, wherein
the comparison unit calculates a correlation value between the motion information acquired by the other communication device and the motion information acquired by the acquisition unit, and
the communication control unit controls communication between the communication unit and the other communication device, on a basis of whether or not the correlation value calculated by the comparison unit exceeds a threshold value.

3. The communication device according to claim 2, wherein
the communication control unit causes the communication unit to communicate a predetermined kind of data with the other communication device, on a basis of the correlation value exceeding the threshold value.

4. The communication device according to claim 3, wherein
the communication control unit causes the communication unit to communicate the predetermined kind of data with the other communication device, on a basis of the correlation value exceeding the threshold value and of the motion information acquired by the acquisition unit having a predetermined pattern.

5. The communication device according to claim 4, wherein
the predetermined pattern includes a pattern in which positive and negative directions of a motion switch.

6. The communication device according to claim 1, wherein
the comparison unit compares motion information indicating a motion of the other communication device after establishment of connection between the communication unit with the other communication device, and motion information acquired by the acquisition unit after the establishment of the connection.

7. The communication device according to claim 1, wherein
motion information acquired by the acquisition unit includes information regarding time variation of an acceleration rate, speed, or a position of the communication device.

8. The communication device according to claim 1,
wherein the motion information acquired by the acquisition unit includes a difference between a specific motion and a motion of the communication device, or a feature value of the motion of the communication device.

9. The communication device according to claim 4, further comprising
a notification unit that notifies of successful communication of the predetermined kind of data.

10. A communication method comprising:
communicating, by a communication device, with another communication device via a human body;
acquiring motion information indicating a motion of the communication device;
comparing motion information acquired by the other communication device with the motion information acquired by the communication device; and
controlling, by a processor, communication between the communication device and the other communication device, on a basis of a result of the comparison.

11. A communication system comprising:
a first communication device having a first acquisition unit that acquires motion information and a first communication unit that transmits information indicating a motion detected by the first acquisition unit; and
a second communication device having a second communication unit that communicates with the first communication unit via a human body, a second acquisition unit that acquires motion information, a comparison unit that compares the motion information acquired by the first communication device and received by the second communication unit with the motion information acquired by the second acquisition unit, and a communication control unit that controls communication between the second communication unit and the first communication unit, on a basis of a result of the comparison by the comparison unit.
